(19) United States
(12) Patent Application Publication
(10) Pub. No.: US 2008/0233337 A1
(43) Pub. Date: Sep. 25, 2008

(54) FLOOR COVERING FOR LIQUID DISPERSION

(75) Inventors: Ernie Wilson, Albermarle, NC (US); Jessie M. Martin, Millersburg, OH (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: INTERNATIONAL AUTOMOTIVE COMPONENTS GROUP NORTH AMERICA, INC., Dearborn, MI (US)

(21) Appl. No.: 12/051,926

(22) Filed: Mar. 20, 2008

Related U.S. Application Data
(60) Provisional application No. 60/896,629, filed on Mar. 23, 2007.

(51) Int. Cl. B32B 33/00; B32B 3/02

(52) U.S. Cl. 428/95; 428/192; 428/97; 428/222

(57) ABSTRACT

A floor covering for the dispersion of a liquid. The floor covering includes an upper layer that is permeable to liquid, a base layer that is substantially impermeable to liquid, and a wicking layer disposed between the upper and base layers. The wicking layer is configured to disperse and promote evaporation of the liquid.

### CROSS-REFERENCE TO RELATED APPLICATIONS

This application claims the benefit of U.S. provisional application Ser. No. 60/896,629 filed Mar. 23, 2007.

### BACKGROUND OF THE INVENTION

### Field of the Invention

The present invention generally relates to a floor covering.

### SUMMARY OF THE INVENTION

In at least one embodiment of the present invention a floor covering is provided. The floor covering includes an upper layer that is permeable to liquid, a base layer that is substantially impermeable to liquid, and a wicking layer disposed between the upper and base layers. The wicking layer is configured to disperse the liquid to promote evaporation of the liquid.

In at least one embodiment of the present invention a floor mat for a motor vehicle is provided. The floor mat may include a base layer, a wicking layer and a carpet layer. The base layer is substantially impermeable to liquid. The base layer has a first surface, a second surface disposed opposite the first surface, and a raised perimeter portion extending from the first surface and around the perimeter of the base layer. The wicking layer is disposed on the first surface within the raised perimeter portion and is made of melamine foam to promote evaporation of liquid. The carpet layer is disposed on the wicking layer and has an upper pile surface and a lower pile surface that is attached to the wicking layer.

In at least one embodiment of the present invention a floor mat for a motor vehicle is provided. The floor mat has a carpet layer, a base layer that is impermeable to the liquid, and a wicking layer disposed between and in direct contact with the carpet layer and the base layer. The wicking layer is configured to disperse the liquid from an initial area to a larger second area. The carpet layer is permeable such that liquid is not trapped by the carpet layer and has a density that allows substantially free passage of the liquid and air into the wicking layer.

### BRIEF DESCRIPTION OF THE DRAWINGS

FIG. 1 is a top view of a floor covering in accordance with one embodiment of the present invention.

FIG. 2 is a fragmentary section view of the floor covering of FIG. 1 along section line 2-2.

FIG. 3 is a top view of the floor covering of FIG. 1 illustrating dispersion of a liquid for accelerated evaporation.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

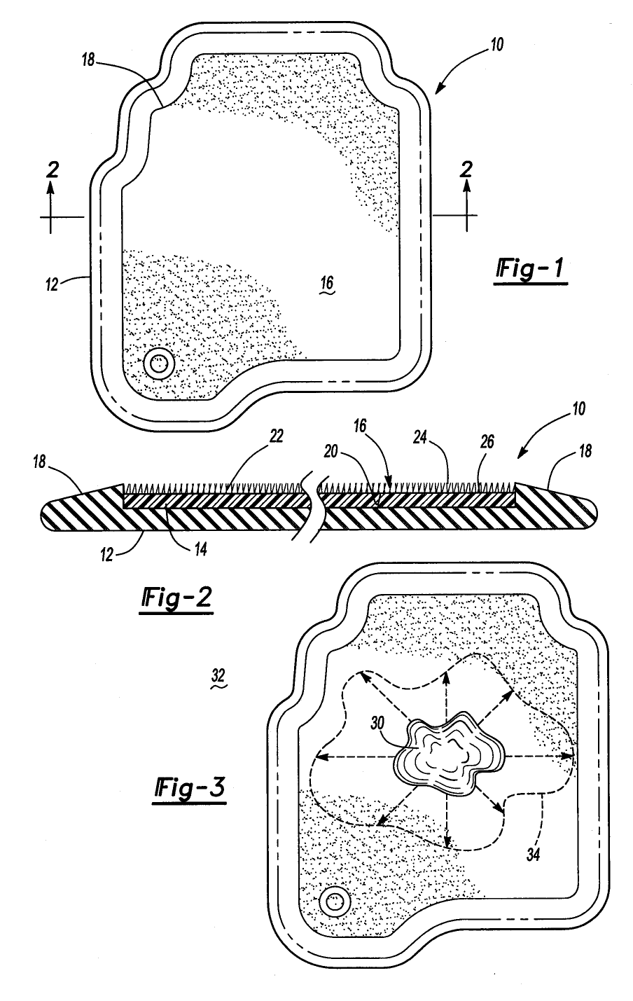

Referring to FIG. 1, a exemplary floor covering 10 in accordance with at least one embodiment of the present invention is shown. The floor covering 10 may cover any suitable floor or support surface. In FIG. 1, the floor covering 10 is configured as a floor mat that may cover a surface of a motor vehicle, such as a vehicle floor or vehicle carpet. Optionally, the floor covering 10 may be provided as at least a part of a vehicle carpet in one or more embodiments of the present invention. The floor covering 10 may also be used in non-vehicular applications. For instance, the floor covering 10 may be configured for commercial and residential applications, such as interior or exterior building floor mats, carpeting, or any other suitable floor covering applications.

Referring to FIG. 2, the floor covering 10 may include a plurality of layers. For example, the floor covering 10 may include a base layer 12, a wicking layer 14, and an upper layer 16.

The base layer 12 may have any suitable configuration. For example, the base layer 12 may be provided as a bottom layer of the floor covering 10. As such, the base layer 12 may support the wicking layer 14. Moreover, the base layer 12 may provide structure and/or help form the floor covering 10 into a desired contour or shape in one or more embodiments of the present invention. The base layer 12 may be made of a material or materials like rubber or latex that are substantially impermeable to liquids, such as water. As such, the base layer 12 may help contain or capture liquids to protect a surface upon which the floor covering 10 is placed.

The base layer 12 may include one or more raised portions 18. The raised portion 18 may provided along the perimeter of the floor covering 10 and may extend toward the wicking and upper layers 14,16 as shown in FIG. 1. As such, the raised portion 18 may help protect the edges of the wicking and upper layers 14,16 and provide a surface that helps contain liquids within the floor covering 10. Optionally, a raised portion 18 may be spaced apart from the perimeter in one or more embodiments of the present invention. For instance, a raised portion 18 may help create a channel for directing liquid or may help create discrete cells or areas that may facilitate the accumulation of a liquid. The base layer 12 may also include one or more protrusions or nibs on a back surface.

The wicking layer 14 may be disposed proximate the base layer 12. In addition, the wicking layer 14 may be attached to the base layer 12 in any suitable manner, such as with an adhesive or other bonding methods. The wicking layer 14 may be configured to receive and help disperse a liquid to promote evaporation. For example, the wicking layer 14 may quickly disperse liquid generally throughout its volume and promote evaporation of the liquid in one or more embodiments of the present invention. As such, the wicking layer 14 may help promote drying of the floor covering 10 after a liquid is applied or spilled on the floor covering 10.

The wicking layer 14 may be made of any suitable material or materials that help disperse and/or promote liquid evaporation, such as an open cell foam, cotton, rayon, or combinations thereof. In at least one embodiment, the open cell foam may include a melamine foam. Melamine foam may include foams based on melamine and formaldehyde that form an organic resin. The melamine foam may be made as a resin that has an interlinking three-dimensional open cellular matrix. The open cellular matrix may permit the passage of air and provide a structure that helps spread or disperse the liquid into the cellular matrix and away from an initial area by means of capillary action. As such, a melamine foams may promote the evaporation of liquids since air can pass through the open cellular matrix to help promote the evaporation of any liquid contained therein.

The upper layer 16 may be disposed proximate the wicking layer 14. For example, the upper layer 16 may contact a surface of the wicking layer 14 in at least one embodiment of the present invention. The upper layer 16 may be fluid permeable to allow air and liquid pass through to the wicking layer 14.

The upper layer 16 may have any suitable configuration. For example, the upper layer 16 may be provided as a carpet layer. As such, the upper layer 16 may include a backing 20 and a plurality of carpet piles 22 that may be configured to allow air and/or liquid to pass through to the wicking layer 14. The upper layer 16 may be made of any suitable material or materials, such as a polymeric and/or non-polymeric materials like nylon, polyester, olefin, acrylic, wool, or cotton.

The backing 20 may be a separate permeable layer made of a permeable material, such as a heat set non-woven polyester fabric, a woven polypropylene fabric, or another appropriate permeable material that may include cotton, nylon, rayon or similar fabrics. Alternatively, the wicking material 14 may form the backing material in one or more embodiments of the present invention.

The carpet piles 22 may be disposed on, within, or extend through the backing 20 in various embodiments of the present invention. The carpet piles 22 may have an upper pile surface 24 and a lower pile surface 26 disposed opposite the upper pile surface 24. Moreover, the backing 20 and/or a portion of the carpet piles 22, such as the lower pile surface 26, may be attached to the wicking layer 14. Optionally, one or more other layers of permeable material may be disposed between the upper layer 16 and the wicking layer 14 in various embodiments of the present invention. The upper layer 16 or other intermediate layers may be attached to the wicking layer 14 in any suitable manner, such as with an adhesive like a styrene butadiene rubber (SBR) latex adhesive.

Referring to FIG. 3, an exemplary representation of the dispersion of a liquid is shown. A liquid or liquid forming substance, such as snow or ice, may be provided on the floor covering 10 in an initial area 30 that constitutes a first percentage of a total surface area of the floor covering 10. If the liquid remained confined to the initial area 30, then the rate at which the liquid evaporates would be determined by an amount of ambient energy per unit area available from a surrounding environment 32. The present invention allows the liquid to be dispersed into the wicking layer 14 as represented by the arrows in FIG. 3. As the liquid disperses it spreads it out to a second area 34 that is larger than the initial area 30. By dispersing the liquid more radiant and conductive energy may be provided to the floor covering 10 from the surrounding environment 32 to increase evaporation. In addition, the passage of air through the wicking layer 14 may allow the liquid to absorb energy by convection. As a result, the rate at which the liquid evaporates may increase. Accordingly, the present invention may facilitate more rapid drying of a floor covering 10.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A floor covering for the dispersion of a liquid to promote evaporation, the floor covering comprising:
an upper layer that is permeable to liquid;
a base layer that is substantially impermeable to liquid; and
a wicking layer disposed between the upper and base layers, the wicking layer being configured to disperse the liquid to promote evaporation of the liquid.

2. The floor covering of claim 1 wherein the upper layer is a carpet layer that includes an upper pile surface and a lower pile surface disposed opposite the upper pile surface, wherein the lower pile surface is attached to the wicking layer.

3. The floor covering of claim 2 wherein a density of the carpet layer is selected to allow substantially free passage of the liquid and air into the wicking layer.

4. The floor covering of claim 1 wherein the wicking layer spreads the liquid through capillary action.

5. The floor covering of claim 1 wherein the wicking layer is an open cell foam having an interlinking three-dimensional open cellular matrix, wherein open cells of the open cell foam are in liquid communication to provide capillary action.

6. The floor covering of claim 1 wherein the wicking layer includes melamine foam.

7. The floor covering of claim 1 wherein the floor covering defines a total surface area, the upper layer has an initial area that receives the liquid and is smaller than the total surface area, and the wicking layer spreads the liquid outwardly away from the initial area over a larger second area.

8. The floor covering of claim 1 wherein the base layer is a rubber material.

9. A floor mat for a motor vehicle, comprising:
a base layer having a first surface, a second surface disposed opposite the first surface, and a raised perimeter portion extending from the first surface and extending around the perimeter of the base layer, wherein the base layer is substantially impermeable to liquid;
a wicking layer disposed on the first surface within the raised perimeter portion, the wicking layer being made of melamine foam to promote evaporation of liquid; and
a permeable carpet layer being disposed on the wicking layer, the carpet layer having an upper pile surface and a lower pile surface, the lower pile surface being attached to the wicking layer.

10. The floor mat of claim 9 wherein the carpet layer is formed of a plurality of loops of yam that extend through a backing layer.

11. The floor mat of claim 10 wherein the wicking layer is the backing layer.

12. The floor mat of claim 9 wherein the raised perimeter portion extends further from the first surface than the upper pile surface.

13. The floor mat of claim 9 wherein the permeable carpet layer permits liquid and air to pass through to the wicking layer so that the permeable carpet layer is dryer than the wicking layer.

14. The floor mat of claim 9 wherein the carpet layer has a density that allows substantially free passage of the liquid and air into the wicking layer so that liquid is not trapped by the carpet layer.

15. The floor mat of claim 9 wherein air passes through the carpet layer to help disperse liquid in the wicking layer.

16. The floor mat of claim 9 wherein the carpet layer includes a backing layer that is attached to the wicking layer and includes at least one of a permeable heat set non-woven polyester fabric and a permeable woven polypropylene fabric.

17. A floor mat for a motor vehicle for promoting evaporation of a liquid, the floor mat comprising:
a carpet layer;
a base layer that is impermeable to the liquid; and
a wicking layer disposed between and in direct contact with the carpet layer and the base layer, the wicking layer being configured to disperse the liquid from an initial area to a larger second area;
wherein the carpet layer is permeable such that the liquid is not trapped by the carpet layer and wherein the carpet layer has a density that allows substantially free passage of the liquid and air into the wicking layer.

18. The floor mat of claim 17 wherein the wicking layer includes an interlinking three-dimensional open cellular matrix.

19. The floor mat of claim 17 wherein the wicking layer disperses the liquid by means of capillary action.
